(19) United States
(12) Patent Application Publication
(10) Pub. No.: US 2013/0090755 A1
(43) Pub. Date: Apr. 11, 2013

(54) NUMERICALLY-CONTROLLED MACHINE TOOL

(71) Applicants: Hidetake Kiryu, Tokyo (JP); Hirokazu Matsushita, Tokyo (JP); Kenji Kura, Tokyo (JP); Akihiko Matsumura, Tokyo (JP); Hideaki Yamamoto, Tokyo (JP); Hiroshi Oishi, Tokyo (JP)

(72) Inventors: Hidetake Kiryu, Tokyo (JP); Hirokazu Matsushita, Tokyo (JP); Kenji Kura, Tokyo (JP); Akihiko Matsumura, Tokyo (JP); Hideaki Yamamoto, Tokyo (JP); Hiroshi Oishi, Tokyo (JP)

(73) Assignee: MITSUBISHI HEAVY INDUSTRIES, LTD., Tokyo (JP)

(21) Appl. No.: 13/643,911

(22) PCT Filed: Jul. 25, 2011
(86) PCT No.: PCT/JP2011/066800

§ 371 Date: Dec. 7, 2012

(30) Foreign Application Priority Data
Aug. 31, 2010 (JP) 2010-193180

(51) Int. Cl. G05B 11/01

(52) U.S. Cl. CPC G05B 11/01
USPC 700/186

(57) ABSTRACT

Provided is a numerically-controlled machine tool provided with: a tool measuring sensor that measures the length and diameter of a tool; a workpiece measuring sensor that measures the three-dimensional shape, and position and orientation of a workpiece in a non-contact manner by laser beam etc.; and a control device, which, after determining the position of the machining starting point and the slope of a reference plane on the basis of information from the workpiece measuring sensor, on the basis of an inputted machining program, machines the workpiece to the intended final form by simulation from the information from the sensors, the position of the machining starting point and the slope of the reference plane, thereby determining whether there are any machining loads greater than or equal to a specified value, and whether any of the workpiece has been left behind, and displays the determined results via a display device.

### TECHNICAL FIELD

The present invention relates to a numerically-controlled machine tool such as a machining center, a horizontal boring machine or a double column piano milling machine.

### BACKGROUND ART

A numerically-controlled machine tool such as a machining center, a horizontal boring machine or a double column plano milling machine has heretofore been configured to determine a machining start point, an inclination of a reference plane, and the like prior to machining by measuring a position of a predetermined portion of a workpiece fixed and supported onto a table, and the like by use of a contact sensor such as a touch probe.

### CITATION LIST

### Patent Literatures

Patent Literature 1: Japanese Patent Application Publication No. Hei 6-055407
Patent Literature 2: Japanese Patent Application Publication No. 2009-163414
Patent Literature 3: Japanese Patent Application Publication No. 2010-108292

### SUMMARY OF INVENTION

### Technical Problem

In the meantime, when a contact sensor such as a touch probe is used in an attempt to three-dimensionally measure a shape of a workpiece, a moving speed (a feeding speed) of the contact sensor such as a touch probe cannot be set very fast in the light of accuracy and significant time is wasted as a consequence.

In view of the above, an object of the present invention is to provide a numerically-controlled machine tool which is capable of quickly measuring an actual three-dimensional condition of a workpiece attached onto a table via a jig or the like.

### Solution to Problem

A numerically-controlled machine tool of the present invention for solving the above problem is characterized in that the machine tool comprises: a main spindle to which a tool is detachably attached and which is configured to rotate the tool; a table configured to fix and support a workpiece; tool measuring means for measuring a length and a diameter of the tool attached to the main spindle; workpiece measuring means for measuring a three-dimensional shape, a position, and an orientation of the workpiece fixed and supported onto the table in a non-contact manner; information displaying means for displaying information; and controlling means for finding a position of a machining start point and an inclination of a reference plane on the basis of information from the work measuring means, then determining at least one of presence of a machining load equal to or above a prescribed value and presence of a portion of the workpiece left unmachined by performing simulation of machining the workpiece on the table to an intended final shape on the basis of an inputted machining program while using information from the tool measuring means and the workpiece measuring means as well as the position of the machining start point and the inclination of the reference plane, and displaying a determined result by using the information displaying means.

Meanwhile, a numerically-controlled machine tool of the present invention according to the numerically-controlled machine tool described above is characterized in that the controlling means is configured to further determine presence of interference of the workpiece side with the tool side by performing the simulation of machining the workpiece on the table to the intended final shape on the basis of the machining program while using the information from the tool measuring means and the workpiece measuring means as well as the position of the machining start point and the inclination of the reference plane, and to display a determined result by using the information displaying means.

Meanwhile, a numerically-controlled machine tool of the present invention according to the numerically-controlled machine tool described above is characterized in that the controlling means is configured to compare the found position of the machining start point and the found inclination of the reference plane with a position of a machining start point and an inclination of a reference plane assumed in the inputted machining program, and when at least one of the found position of the machining start point and the found inclination of the reference plane does not comply with at least one of the assumed position of the machining start point and the assumed inclination of the reference plane, to display information indicating the non-compliance by using the information displaying means.

Meanwhile, a numerically-controlled machine tool of the present invention according to the numerically-controlled machine tool described above is characterized in that the controlling means is configured to compare the shape of the workpiece on the table measured by the workpiece measuring means with a shape of the workpiece assumed in the inputted machining program, and when the shape of the workpiece on the table does not comply with the assumed shape of the workpiece, to display information indicating the non-compliance by using the information displaying means.

### Advantageous Effect of Invention

According to a numerically-controlled machine tool of the present invention, the three-dimensional shape, the position, and the orientation of the workpiece fixed and supported onto the table are measured with the workpiece measuring means in a non-contact manner. Thus, an actual three-dimensional condition of the workpiece attached onto the table via a jig or the like can be quickly measured.

### BRIEF DESCRIPTION OF DRAWINGS

FIG. 1 is a schematic configuration diagram of a main embodiment of a numerically-controlled machine tool according to the present invention.

FIG. 2 is a control block diagram of principal part of the main embodiment of the numerically-controlled machine tool according to the present invention.

FIG. 3 is a control flowchart of the principal part of the main embodiment of the numerically-controlled machine tool according to the present invention.

### DESCRIPTION OF EMBODIMENTS

An embodiment of a numerically-controlled machine tool according to the present invention will be described below with reference to the drawings. It is to be noted, however, that the present invention is not limited only to the embodiment described with reference to the drawings.

### Main Embodiment

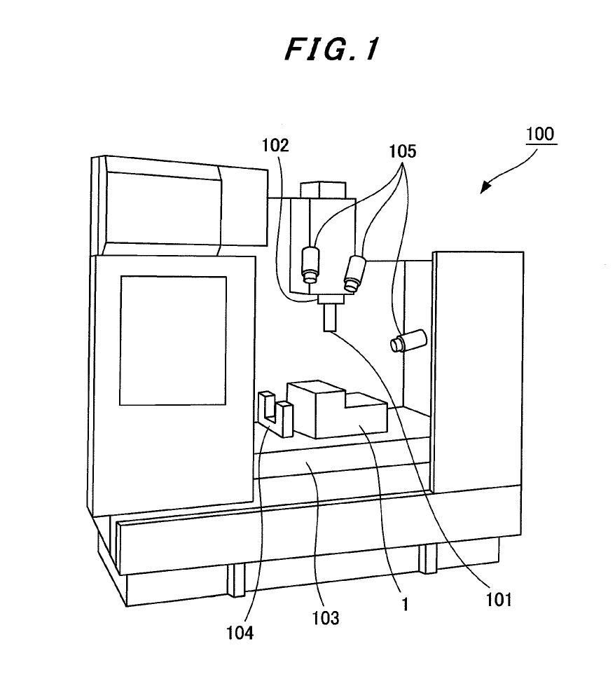

A main embodiment of a numerically-controlled machine tool according to the present invention will be described with reference to FIGS. 1 to 3.

As shown in FIG. 1, a numerically-controlled machine tool 100 of this embodiment includes: a main spindle 102 to which a tool 101 can be detachably attached and which is configured to rotate the tool 101; a table 103 configured to fix and support a workpiece 1; a tool measuring sensor 104 serving as tool measuring means for measuring two-dimensional shapes, namely, a length and a diameter of the tool 101 attached to the main spindle 102; and workpiece measuring sensors 105 serving as workpiece measuring means for measuring a three-dimensional shape of a combination of a jig and the workpiece 1 fixed and supported onto the table 103 in a non-contact manner with a laser beam or the like.

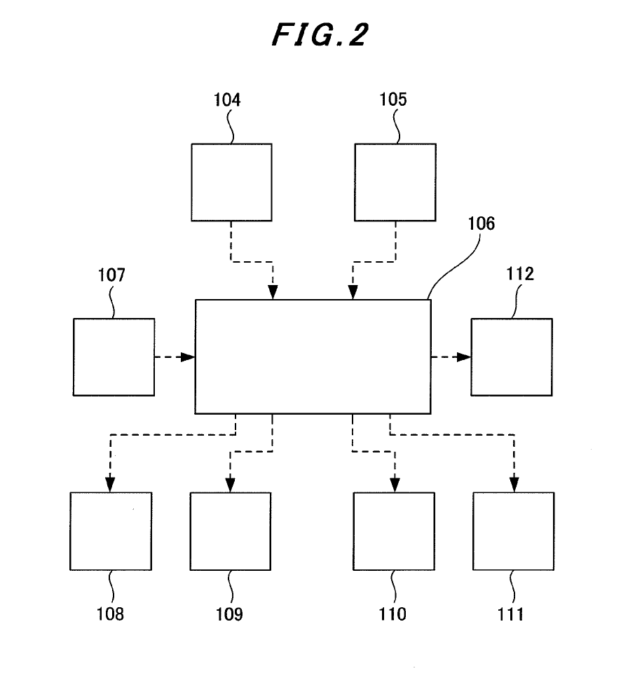

In addition, as shown in FIG. 2, the tool measuring sensor 104 and the workpiece measuring sensors 105 are electrically connected to an input unit of a control device 106 serving as controlling means. Moreover, an input device 107 serving as inputting means for inputting various machining conditions including a machining program and the like is electrically connected to the input unit of the control device 106.

In the meantime, an output unit of the control device 106 is electrically connected to each of: a drive motor 108 which is configured to rotate the tool 101 attached to the main spindle 102; drive motors 109 to 111 which are configured to move the main spindle 102 and the table 103 in such a manner as to move the tool 101 and the workpiece 1 relatively in X, Y, and Z axis directions; and a display device 112 serving as information displaying means such as a speaker or a monitor for displaying a variety of information in the form of sounds or images. The control device 106 is capable of controlling actions of the motors 108 to 111 on the basis of information from the sensors 104, 105 and information inputted from the input device 107, and of displaying the variety of information on the display device 112 (to be described later in detail).

Next, actions of the numerically-controlled machine tool 100 of this embodiment will be described.

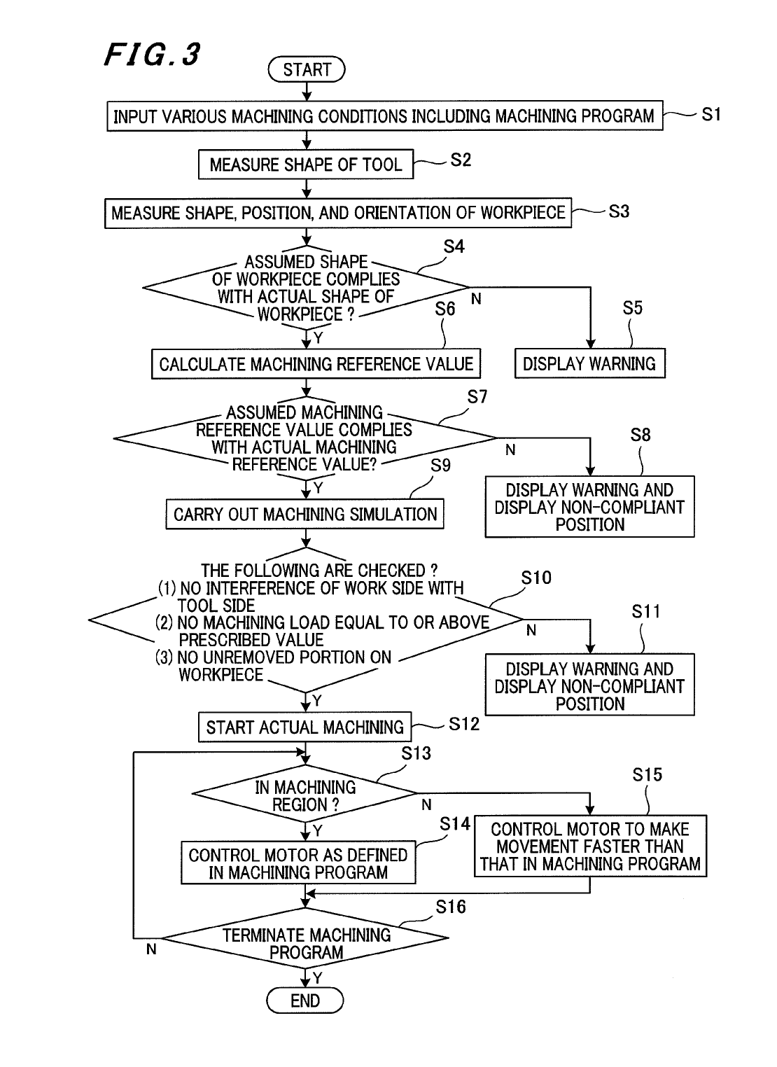

First, various machining conditions including the machining program are inputted to the control device 106 by using the input device 107 (S1 in FIG. 3). When the tool 101 is attached to the main spindle 102, the control device 106 activates the motors 109 to 111 and thereby moves the tool 101 and the tool measuring sensor 104 relatively in the X, Y, and Z axis directions (S2 in FIG. 3) in such a manner as to measure the two-dimensional external sizes including the length and the diameter of the tool 101 with the tool measuring sensor 104.

Thus, the control device 106 determines the actual two-dimensional external sizes of the tool 101 including a length between an end of the main spindle and a tip of the tool 101, a diameter on the tip side, and the like on the basis of the information from the tool measuring sensor 104.

Subsequently, when the workpiece 1 is fixed and supported onto the table 103 via the jig, the control device 106 activates the motors 109 to 111 and thereby moves the workpiece measuring sensors 105 and the workpiece 1 relatively in the X, Y, and Z axis directions (S3 in FIG. 3) in such a manner as to measure the three-dimensional external shape, a position, and an orientation of the combination of the jig and the workpiece 1 on the table 103 with the workpiece measuring sensors 105.

Thus, the control device 106 determines the actual three-dimensional external shape, position, and orientation of the combination of the jig and the workpiece 1 on the table 103 on the basis of the information from the workpiece measuring sensors 105.

Next, the control device 106 determines compliance between the inputted machining program and the workpiece 1 on the basis of the actual external shape of the tool 101 and the actual external shape, position, and orientation of the workpiece 1 determined as described above.

Specifically, the control device 106 first compares a shape of the workpiece assumed in the machining program inputted from the input device 107 with the actual shape of the workpiece 1 on the table 103 on the basis of the actual external shape of the workpiece 1, and determines whether or not a content of machining to be carried out complies with the workpiece 1 to be machined (S4 in FIG. 3). When the shape of the workpiece assumed in the machining program does not comply with the shape of the workpiece 1 on the table 103, namely, when the content of machining to be carried out does not conform to the workpiece 1 to be machined, the control device 106 warns an operator by displaying such a fact on the display device 112 (S5 in FIG. 3).

When the shape of the workpiece assumed in the machining program complies with the shape of the workpiece 1 on the table 103, namely, when the content of machining to be carried out conforms to the workpiece 1 to be machined, the control device 106 subsequently finds machining reference values including a position of a machining start point, an inclination of a reference plane, and the like on the basis of the position and orientation of the workpiece 1 (S6 in FIG. 3).

Then, the control device 106 determines whether or not the actual position and orientation of the workpiece 1 on the table 103 comply within normal ranges (S7 in FIG. 3) by comparing the actual machining reference values including the position of the machining start point, the inclination of the reference plane, and the like thus found with assumed machining reference values including the position of the machining start point, the inclination of the reference plane, and the like which are assumed in the inputted machining program. When the actual machining reference values do not comply with the assumed machining reference values, namely, when the actual position and orientation of the workpiece 1 on the table 103 are misaligned, the control device 106 warns the operator by displaying such a fact on the display unit 112, and displays the information indicating the position and orientation of the non-compliant workpiece 1 (S8 in FIG. 3).

When the actual machining reference values comply with the assumed machining reference values, namely, when the actual position and orientation of the workpiece 1 on the table 103 are compliant, the control device 106 performs simulation of machining the actual workpiece 1 inclusive of the jig on the table 103 to an intended final shape (S9 in FIG. 3) on the basis of the various machining conditions including the inputted machining program and the like, the measured actual two-dimensional shapes including the length and the diameter of the tool 101, the measured actual three-dimensional shape of the workpiece 1, and the found actual machining reference values including the position of the machining start point, the inclination of the reference plane, and so forth.

Presence of any of the following machining problems is checked (S10 in FIG. 3) by carrying out the machining simulation of the actual workpiece 1 to the intended final shape:

(1) Presence of interference of the workpiece 1 side inclusive of the jig or the like with the tool 101 side such as a slide (a ram);
(2) Presence of a machining load equal to or above a prescribed value (a machining allowance of a size equal to or above the prescribed value); and
(3) Presence of a portion of the workpiece 1 left unmachined.

Here, if there is any of the above-mentioned problems, the control device 106 warns the operator by displaying such a fact on the display device 112, and displays details (position, magnitude, and the like) of such a problem (S11 in FIG. 3).

On the other hand, when there are none of these problems, the control device 106 starts control of the actions of the motors 108 to 111 in order to perform actual machining on the workpiece 1 on the table 103 in a similar manner to the machining simulation (S12 in FIG. 3).

Then, the control device 106 continues the actual machining on the basis of the machining simulation. In a machining region where the tool 101 is in contact with the workpiece 1 (S13 in FIG. 3), the control device 106 controls the actions of the motors 109 to 111 (S14 in FIG. 3) in such a manner as to relatively move the main spindle 102 and the table 103 according as defined in the machining program. On the other hand, in a non-machining region where the tool 101 moves without being in contact with the workpiece 1, the control device 106 controls (overrides) the actions of the motors 109 to 111 (S15 in FIG. 3) in such a manner as to move the tool 101 relatively to the workpiece 1 at a higher speed than the moving speed such as the feeding speed of the tool 101 defined in the machining program.

Then, the actual machining on the workpiece 1 is terminated as the machining program is terminated (S16 in FIG. 3).

In other words, the numerically-controlled machine tool 100 of this embodiment is configured to find the actual three-dimensional shape of the workpiece 1 inclusive of the jig or the like by using the workpiece measuring sensors 105 which perform measurement in a non-contact manner with a laser beam or the like.

Accordingly, the numerically-controlled machine tool 100 of this embodiment can quickly measure the actual three-dimensional condition of the workpiece 1 attached onto the table 103 via the jig or the like. In addition, the following advantageous effects can be achieved as well.

(1) It is possible to considerably simplify a conventional operation so-called a debugging operation, in which the machining program is executed while moving the main spindle 102 away before machining is actually performed on the workpiece 1; meanwhile, the operator visually checks a relation concerning an acting position (such as the presence of the interference, the degree of fluctuation of the machining allowance or the presence of the portion left unmachined) of the main spindle 102 with the workpiece 1 and the operator performs adjustment so as to reflect a result of the check in the actual machining. Thus, a burden on the operator can be significantly reduced and fluctuation attributed to an experience level of the operator can be eliminated.
(2) The moving speed such as the feeding speed of the tool 101 is overridden when the tool 101 is in the non-machining region in the course of the actual machining. Thus, processing time can be significantly reduced.

### Other Embodiments

The foregoing embodiment has described the case of providing the workpiece measuring sensors 105 configured to measure the three-dimensional shape and the like of the workpiece 1 in a non-contact manner with a laser beam or the like. Instead, as another embodiment, it is possible to provide a CCD camera configured to shoot the three-dimensional shape and the like of the workpiece 1, for example.

Meanwhile, in the foregoing embodiment, the tool measuring sensor 104 configured to measure the shapes including the length, the diameter, and the like of the tool 101, and the workpiece measuring sensors 105 configured to measure the three-dimensional shape and the like of the workpiece 1 in a non-contact manner are provided. Instead, as another embodiment, it is possible to provide measuring means for measuring the shapes including the length, the diameter, and the like of the tool 101 and measuring the three-dimensional shape and the like of the workpiece 1 in such a manner as to serve as both of the tool measuring sensor 104 and the workpiece measuring sensors 105, for example.

Meanwhile, in the foregoing embodiment, the interference of the workpiece 1 side inclusive of the jig or the like with the tool 101 side such as the slide (the ram) is checked in the machining simulation prior to the actual machining. Instead, as another embodiment, it is possible to conduct machining while performing simulation of a state ahead of a point of machining (such as 5 seconds ahead) during the actual machining, for example. Here, when occurrence of the interference of the workpiece 1 side inclusive of the jig or the like with the tool 101 side such as the slide (the ram) is predicted, the controlling means is caused to warn the operator by displaying such a fact on the displaying means, to display a position of the interference, and to suspend the machining. In other words, the controlling means can be provided with a crash prevention function (see PTL 1, for example).

In the meantime, the foregoing embodiment has described the case of checking the presence of both the machining problems of the machining load equal to or above the prescribed value (the machining allowance of a size equal to or above the prescribed value) and the portion of the workpiece 1 left unmachined. However, depending on various conditions such as accuracy associated with a manufacturing history of the workpiece 1, it is possible to check the presence of only one of the machining problems of the machining load equal to or above the prescribed value (the machining allowance of a size equal to or above the prescribed value) and the portion of the workpiece 1 left unmachined.

In addition, the present invention is applicable as described in the foregoing embodiment to a numerically-controlled machine tool such as a machining center, a horizontal boring machine or a double column piano milling machine.

### INDUSTRIAL APPLICABILITY

A numerically-controlled machine tool according to the present invention is capable of quickly measuring an actual three-dimensional condition of a workpiece attached onto a table via a jig or the like, and is therefore extremely useful in metal processing industries and the like.

### REFERENCE SIGNS LIST

1 workpiece
100 numerically-controlled machine tool
101 tool
102 main spindle
103 table
104 tool measuring sensor
105 workpiece measuring sensor
106 control device
107 input device
108 to 111 drive motor
112 display device

1. A numerically-controlled machine tool comprising:
a main spindle to which a tool is detachably attached and which is configured to rotate the tool;
a table configured to fix and support a workpiece;
tool measuring means for measuring a length and a diameter of the tool attached to the main spindle;
workpiece measuring means for measuring a three-dimensional shape, a position, and an orientation of the workpiece fixed and supported onto the table in a non-contact manner;
information displaying means for displaying information; and
controlling means for finding a position of a machining start point and an inclination of a reference plane on the basis of information from the work measuring means, then determining at least one of presence of a machining load equal to or above a prescribed value and presence of a portion of the workpiece left unmachined by performing simulation of machining the workpiece on the table to an intended final shape on the basis of an inputted machining program while using information from the tool measuring means and the workpiece measuring means as well as the position of the machining start point and the inclination of the reference plane, and displaying a determined result by using the information displaying means.

2. The numerically-controlled machine tool according to claim 1, wherein the controlling means is configured to further determine presence of interference of the workpiece side with the tool side by performing the simulation of machining the workpiece on the table to the intended final shape on the basis of the machining program while using the information from the tool measuring means and the workpiece measuring means as well as the position of the machining start point and the inclination of the reference plane, and to display a determined result by using the information displaying means.

3. The numerically-controlled machine tool according to claim 1, wherein the controlling means is configured to compare the found position of the machining start point and the found inclination of the reference plane with a position of a machining start point and an inclination of a reference plane assumed in the inputted machining program, and when at least one of the found position of the machining start point and the found inclination of the reference plane does not comply with at least one of the assumed position of the machining start point and the assumed inclination of the reference plane, to display information indicating the non-compliance by using the information displaying means.

4. The numerically-controlled machine tool according to claim 1, wherein the controlling means is configured to compare the shape of the workpiece on the table measured by the workpiece measuring means with a shape of the workpiece assumed in the inputted machining program, and when the shape of the workpiece on the table does not comply with the assumed shape of the workpiece, to display information indicating the non-compliance by using the information displaying means.
